(19) United States
(12) Patent Application Publication
(10) Pub. No.: US 2014/0356517 A1
(43) Pub. Date: Dec. 4, 2014

(54) SNACK FOOD

(71) Applicants: Claudia URIBE, Tuckahoe, NY (US); Steve V. Mendal, Tuckahoe, NY (US); Ilanit Blumenfeld, Tuckahoe, NY (US)

(72) Inventors: Claudia URIBE, Tuckahoe, NY (US); Steve V. Mendal, Tuckahoe, NY (US); Ilanit Blumenfeld, Tuckahoe, NY (US)

(21) Appl. No.: 14/268,208

(22) Filed: May 2, 2014

Related U.S. Application Data
(60) Provisional application No. 61/828,746, filed on May 30, 2013.

(51) Int. Cl. A23G 3/48

(52) U.S. Cl. CPC A23G 3/48
USPC 426/640; 426/660; 426/385

(57) ABSTRACT

The invention provides a freeze-dried dulce de leche pieces. The invention further provides a snack food or confection including freeze dried fruit and dulce de leche wherein the dulce de leche is formed into pyramidal pieces, freeze dried to a final moisture content of about two to three percent or less, and admixed with grains, seeds, fiber or fruit powders.

### FIELD OF THE INVENTION

The invention relates to a caramel snack food, in particular freeze-dried dulce de leche in pieces by itself and with added flavors and benefits. In addition, the products obtained by combining this new product in different ways.

### BACKGROUND OF THE INVENTION

The market for natural food sales have been growing at 4-5%, more than two points over regular counterparts and consumers' interest is increasing as people use natural food as preventive medicine, and address concerns with obesity, processed foods and pesticides. The fruits snacks category specialty, has grown a healthy 7%.

In parallel, snacking has increased up to 3-4 times a day, from 0-2 times a day only a few years ago. People are having more but smaller meals throughout the day and snacking is perceived now as part of a balanced diet, and a way to sustain energy and satisfy cravings.

There is also an awareness of consuming 4 to 5 servings a day of fruits and/or vegetables; busy, on-the-go consumers also make convenience an important variable to consider.

The present invention addresses these concerns, providing not only a functional and convenient snack, but also a tasty and indulgent one. By introducing the freeze-dried dulce de leche pieces by themselves, or infused with grains, seeds or portions thereof, (flaxseeds, quinoa, fiber, fruit powders, etc.) and combining both kinds with freeze-dried crunchy fruits in a convenient single serve bags, you get an overall healthy snack.

Current offerings of dulce de leche from Latin America are only offered in the market in its original paste-like form, in plastic containers, aluminum cans and squeezable tubes, to be used as a spread, eaten with spoons, or as an ingredient for baking. It is also found with coconut flavor. American caramel-type products are offered in solid shape and wrapped in cellophane as candies that are chewy when consumed.

The current invention creates a different form of dulce de leche that can be eaten in new ways.

### SUMMARY OF THE INVENTION

The invention relates to a new form of dulce de leche a type of caramel first produced in Latin America. The ingredients of dulce de leche in original form are approximately: sugar 40.1%, whole milk powder 37.5%, water 20.7% and sodium bicarbonate 1.74%. The dulce de leche in its original form has a thick and dense texture similar to peanut butter in consistency and it is usually used as a spread with a knife on bread for example, eaten by itself on a spoon and it is considered a delicacy in many Latin American countries; in Colombia, for example, its often served alongside cheese as a dessert. Dulce de leche, or arequipe as it is called in Colombia is also used as an intermediate ingredient in food products such as ice cream, cakes and bakery items around the world.

The invention relates to a new product, freeze dried dulce de leche pieces, freeze dried dulce de leche pieces with ground flaxseed (or other grains, seeds or fiber and/or fruit powders), as well as the product obtained by having these dulce de leche pieces combined with freeze dried slices of fruits. In its original form, dulce de leche is placed in V-shaped piping bags, and squeezed to form a new shape (similar in shape to a Hershey's Kiss), and through the freeze-drying process, 95% of the moisture is removed, hardening the dulce de leche and transforming it into a crunchy, crispy, and light treat that can be used as a snack or topping. Different from dense toffee, the freeze-drying process leaves the dulce de leche porous and airy. Additionally, its airiness in freeze-dried form provides for a lower-calorie dulce de leche treat. In addition, the lack of water makes this product shelf stable since low moisture prevents enzyme activity that causes spoilage. From a nutrition perspective, the dulce de leche pieces admixed with ground flaxseed become functional from the Omega-3 Fatty Adds and antioxidants found in ground flaxseed. Preferably, the amount of moisture in the dulce de leche should be 0.4-2 percent or less.

The invention also relates to the mixes that are created with fruits and the dulce de leche pieces, when placed into the same individual bag. The two innovative mixes are freeze dried strawberry slices and dulce de leche pieces, and freeze dried dragon fruit and dulce de leche pieces mixed with ground flaxseed. Other fruits or berries may be used, such as blueberries, raspberries, blackberries, kiwis, apples, bananas, pears, peaches, pineapple, grapes, and apricots. More exotic fruits that may be used include gooseberries, guava, maqui berries, grapes, acai, jackfruit, durian, mangosteen, rambutan, longan, passion fruit, lychee, papaya, cantaloupe, honeydew and other melons, feijoa, and figs, and other fruits susceptible of freeze drying, offering a wide variety of fruit snacks to consumers. With some kinds of fruit, it may be desirable to omit the slicing step, as they may be small enough to be bite sized in freeze-dried form.

### DETAILED DESCRIPTION OF THE PREFERRED EMBODIMENTS

The following examples are meant to illustrate the practices of the invention but not limit its scope, which is defined by the claims appended hereto.

### EXAMPLE 1

### Freeze-Dried Dulce de Leche Pieces

The current invention is a new form of dulce de leche, that is easily portable, consumed without utensils and more light and longer lasting given the change in humidity content from its original form.

The new product not only has different physical characteristics of consistency and structure than the dulce de leche in original form, but also in composition.

| General | Original Dulce | |
|---|---|---|
| characteristics | de Leche | Freeze-dried Dulce de Leche |
| Consistency | Dense, thick, | Firm, and crunchy; but porous, |
| | heavy | airy, light |
| Added | Needs | No need of preservatives, because |
| ingredients | preservatives | reduction in water, inhibits |
| | to last | enzymes activity that causes |
| | | spoilage |
| Form | No form, | Chips, pyramid shape, with diameter |
| | determined by | in 10-15 mm |
| | container where | |
| | it is placed | |
| Uses | Spread; by itself | In snacks, can be held in hand and |
| | with spoon, as | consumed without utensils; used |
| | ingredient in | as topping in salads, yogurts or ice |
| | bakery | creams |
| Color and taste | Dark yellow; | Dark ocher; characteristics of |
| | characteristics of | dulce de leche |
| | dulce de leche | |

Different from dense toffee, the freeze-drying process leaves the dulce de leche porous and airy; this airiness in freeze-dried form provides for a lower-calorie dulce de leche treat. In addition, the lack of water makes this product shelf stable since low moisture prevents enzyme activity that causes spoilage. Preferably, the amount of moisture in the freeze-dried dulce de leche should be 0.4-3% percent or less, and the fat content when freeze-dried 8%.

| Physical | | |
|---|---|---|
| composition | Original Dulce de Leche | Freeze-dried Dulce de Leche |
| Dairy solids | 24% | 33.3% |
| Ashes | 2% | 2.8% |
| Other solids | 44% | 60.9 |
| Humidity | 30% | 3% |

Freeze-dried Dulce de leche pieces also maintain their smell, characteristic of dulce de leche and its color, dark ocher.

In order to maintain the product as natural as possible, our freeze-dried dulce de leche does not need to contain preservatives like maltodextrin, which the original form of dulce de leche needs in order to maintain freshness. This is because the freeze-drying process extracts all the moisture from the dulce de leche, in effect, maintaining freshness and eliminating the need of preservatives, like maltodextrin.

### EXAMPLE 2

### Freeze-Dried Dulce de Leche Pieces with Added Seeds, Grains, Fiber or Fruit Powders

The second embodiment relates to freeze dried dulce de leche pieces with added flavors or nutritional benefits. From a nutrition perspective, the dulce de leche pieces admixed with for example, ground flaxseed become functional from the Omega-3 Fatty Acids, fiber and antioxidants found in ground flaxseed.

The freeze-dried dulce de leche pieces maintain their physical and composition characteristics, and equal humidity of 3 or less than 3%. The only change is in flavor; when flaxseeds in powder are added to the Dulce de leche it becomes less sweet; or if passion fruit powder is added to the dulce de leche pieces, its flavor becomes softer and has a hint characteristic of passion fruit flavor. Usually the percentage added to the dulce de leche would be 10% or less of the total mixture, but it can fluctuate depending on taste. The product must be frozen, so the trays are put in a cold room at a temperature between −10 and −25°0 C., for 1 to 6 hours. After this, the trays are placed in a high vacuum chamber to perform the sublimation process (where the water contained in the product passes from solid state (ice) to gaseous state without passing through the liquid state). The pressure is controlled between 0.05 mbar and 2 mbar, for about 4 to 10 hours, until completion. The dulce de leche is reduced in weight by a factor of 10 to 13 to 1 from start to finish of the freeze dried process.

After the freeze-drying process is complete, the trays are removed out from the chambers, and the pieces are removed from the trays. The dulce de leche is selected according with the quality criteria (color, flavor, smells and appearance), and packed temporarily in high density polypropylene bags, while the final individual packages are prepared.

### EXAMPLE 3

### Process of Freeze Drying Dulce de Leche Pieces and Admixing Seeds, Grains, Fibers, and/or Fruit Powders

The raw materials, Dulce de leche in original form (and flaxseed) are received and analyzed according to pre-determined quality criteria (color, taste, smell and appearance). The dulce de leche product presents soft, smooth, elastic texture and firm appearance and is made using sterilized whole milk, sugar and sodium bicarbonate. Dulce de leche is received in bilk in 50 kilogram plastic containers. Natural flaxseed is received as a granulated powder, light brown, and with the specific smell of flaxseed. The temporary packing material (high density polyethylene) is also received and stored in a sanitary place.

First, the dulce de leche is mixed manually in a proportion of 10% of total weight flaxseed to dulce de leche. The amount of ground flaxseed or other seed grain, fiber, or fruit powder used is carefully measured so as not to change the original flavor of freeze dried dulce de leche, and can be easily adjusted by a person of ordinary skill. Preferably, the amount of added seeds, grains, fiber, or fruit powder should not exceed 10% in order to avoid altering the flavor. This process is carried out in a plastic container where each ingredient is added according to an agreed proportion. The blend is made manually with the help of a plastic ladle until it is totally homogeneous and uniform.

To produce the pieces/chips (With and Without Ground Flaxseed), the dulce de leche in its original form is placed in V-shaped piping bags with a 10 mm tip, and squeezed out manually, one by one onto a tray forming an oval chip shape measuring between 10-15 mm in diameter. In order to produce each chip, pressure is made to the pastry/piping bag, so that the dulce de leche goes through the tip forming the piece/chip. An automated dispensing machine that produces pyramid shaped (or Hershey Kiss shaped) pieces of desired weight (approximately 1.5 grams per piece) can be used to form the dulce de leche pieces for the freeze-drying process.

This product in trays starts the freeze-drying process. The dulce de leche pieces are next frozen. The trays are carried into a cold room, with temperatures between −10 and −25° for 1 to 6 hours.

After freezing time is complete, trays are taken into a high vacuum chamber with a pressure of 0.05 to 2 mbar to produce the sublimation process (where water is taken from solid to gaseous state) between 4 and 10 hours. During this freeze-drying process dulce de leche pieces are left with 0.4-2% of moisture, hardening the dulce de leche and transforming it into a crunchy, crispy, and light treat that can be used as a snack or topping. Different from dense toffee, the freeze-drying process leaves the dulce de leche porous and airy. The crunchiness of the dulce de leche freeze-dried pieces, is characterized by having a rigid structure (cellular aggregates) that suddenly collapses with a brittle separation into small pieces under simple compression with little grinding. Additionally, its airiness in freeze-dried form provides for a lower-calorie dulce de leche treat, than its original counterpart per unit weight. The dulce de leche is reduced in weight by a factor of about 10 to 1, starting with 20 percent water and ending with about 2 to 3 percent water.

Finally, after the freeze-drying process, the trays are discharged from the machine, and the product is removed from them with a stainless steel spatula. The freeze-dried dulce de leche pieces are selected according to the quality criteria, specifically crunchiness and texture. In addition, other variables are evaluated such as flavor, color, smell and appearance. Then it is packed in high density polyethylene bags, to be stored waiting for the individual packaging.

The dulce de leche has a yield of 60%, meaning that for 1 kg of dulce de leche in its original form/fresh, 600 grams of freeze-dried dulce de leche is obtained. For every 100 grams of freeze-dried dulce de leche, there are 65 chips produced. This means that every chip in freeze-dried form weighs approx. 1.5 grams, and every chip in fresh/original form weighs approximately 2.5 grams.

### EXAMPLE 4

### Process for Freeze Drying the Fruit

The fruit (strawberry and dragon fruit in this example) is received and evaluated according to the quality criteria (color, flavor, smell and appearance), to be used in making the product of the present invention. The fruit and other raw materials are stored in high density polypropylene protective packaging material. This material is stored in a place specially designed for this purpose.

After receiving the fruit, it is classified manually. In this process, we separate the fruit according to its maturity. The fruit that is ready to be processed is weighed, taking into account the capacity of the machines and fruit yield. The product is immersed for 2 to 5 minutes in a sanitize solution 200 ppm (quaternary ammonium), for disinfection and then it is rinsed and drained.

The next step is to slice the fruit. For strawberries, stems are removed manually, and then cut into slices 5 to 7 mm wide. For dragon fruit, skin must be removed, and the fruit pulp is separated from the skin with a spoon, after which it is cut into slices 5 to 7 mm wide. All the sliced fruit is then placed into different trays.

The product must be frozen, so the trays are put in a cold room at a temperature between −10 and −25° C., for 1 to 6 hours. After this, the trays are placed in a high vacuum chamber to perform the sublimation process (where the water contained in the product passes from solid state (ice) to gaseous state without passing through the liquid state). The pressure is controlled between 0.05 mbar and 2 mbar, for about 4 to 10 hours, until completion. The fruit is reduced in weight by a factor of 10 to 13 to 1 from start to finish of the freeze dried process.

After the freeze-drying process is complete, the trays are removed out from the chambers, and the fruit is removed from the trays. The freeze dried fruit is selected according with the quality criteria (color, flavor, smells and appearance), and packed temporarily in high density polypropylene bags, while the dulce de leche pieces are freeze dried and the final individual packages are prepared.

### EXAMPLE 5

### Packaging

When all the ingredients and packaging are ready, the fruit, the dulce de leche pieces, and the individual bags, the mix is prepared.

The freeze-dried strawberry slices and Dulce de Leche pieces are mixed manually in 70/30 proportion, and filled at a rate of 17 grams per individual bag. The bag protects against light and humidity so the product maintains freshness and crunchiness. Then the package is sealed, such as in a sealing conveyor.

The freeze-dried Dragon Fruit slices and Dulce de Leche pieces with ground flaxseed are mixed manually in an approximately 65/35 proportion, and filled at a rate of 17 grams per individual bag. The proportion of fruit to dulce de leche may range from about 30 to 70 percent fruit and about 70 to about 30 percent dulce de leche, with about 60 to 70 percent fruit and about 30 to 40 percent dulce de leche preferred. The bag protects against light and humidity so the product maintains freshness and crunchiness. Then the package is sealed, such as, in a sealing conveyor.

### EXAMPLE 6

### Preparation of Fruit

The fruit (strawberry and dragon fruit in this example) is received and evaluated according to the quality criteria (color, flavor, smell and appearance), to be used in making the product of the present invention. The fruit and other raw materials are stored in high density polypropylene protective packaging material. This material is stored in a place specially designed for this purpose.

After receiving the fruit, it is classified manually. In this process, we separate the fruit according to its maturity. The fruit that is ready to be processed is weighed, taking into account the capacity of the machines and fruit yield. The product is immersed for 2 to 5 minutes in a sanitizer solution 200 ppm (quaternary ammonium), for disinfection and then it is rinsed and drained.

The next step is to slice the fruit. For strawberries, stems are removed manually, and then cut into slices 5 to 7 mm wide. For dragon fruit, skin must be removed, and the fruit pulp is separated from the skin with a spoon, after which it is cut into slices 5 to 7 mm wide. All the sliced fruit is then placed into different trays.

What is claimed is:

1. A candy confection comprising:
freeze dried dulce de leche having a crunchy but porous and airy consistency;
a pyramidal chip shape with a diameter of about 10-15 mm;
a dark yellow caramel color and having the following physical compositions:
dairy solids—about 30-35% by wt.;
ash—about 2-3% by wt.;
other solids—about 55-65% by wt.; and
humidity—about 2-4%.

2. A candy confection as in claim 1, further comprising an added ingredient of whole or partial seeds, grains, fiber, or fruit powder or flavoring, wherein the added ingredient is administered in proportion equal to or less than 10% by wt. of finished product.

3. A candy confection as in claim 1, additionally comprising freeze dried fruit slices or pieces.

4. A confection as in claim 2, additionally comprising freeze dried fruit slices or pieces.

5. A method for making a freeze dried candy confection, comprising:
preparing or providing an amount of dulce de leche;
forming the dulce de leche into pyramid shaped pieces; and
freeze drying, the pyramid shaped dulce de leche pieces such that the freeze dried dulce de leche pieces have a moisture content of about two to three percent or less.

6. A method for making a freeze dried candy confection, with seeds or fruit powders, comprising:
preparing or providing, a quantity dulce de leche;
admixing the dulce de leche with whole or partial seeds or grains, fiber, or fruit flavoring or powder;
forming the dulce de leche into pyramid shaped pieces; and
freeze drying the pyramid shaped dulce de leche pieces such that the freeze dried dulce de leche pieces have a moisture content of about two to three percent or less.

7. A method for making a snack food comprising:
freeze drying slices of fruit;
providing a supply of dulce de leche;
forming the dulce de leche into pyramid shaped pieces;
freeze drying the dulce de leche pieces such that the moisture content is about two to three percent or less;
mixing freeze dried dulce de leche pieces with the freeze dried fruit.

8. A candy confection made according to the method of claim 5.

9. A candy confection made according to the method of claim 6.

10. A snack food made according to the method of claim 7.
